(19) United States
(12) Patent Application Publication
(10) Pub. No.: US 2025/0333582 A1
(43) Pub. Date: Oct. 30, 2025

(54) GAP FILLER COMPOSITION AND BATTERY PACK

(71) Applicant: DONGWOO FINE-CHEM CO., LTD., Jeollabuk-do (KR)

(72) Inventors: MIN KYU SIM, Jeollabuk-do (KR); WOO JUN SHIN, Jeollabuk-do (KR); DONG CHAN LEE, Jeollabuk-do (KR)

(21) Appl. No.: 19/259,365

(22) Filed: Jul. 3, 2025

Related U.S. Application Data
(63) Continuation of application No. PCT/KR2024/000577, filed on Jan. 12, 2024.

(30) Foreign Application Priority Data
Jan. 17, 2023 (KR) 10-2023-0006628

(51) Int. Cl. C08K 9/06; B01J 31/12; C08K 3/20; C08K 3/22; H01M 10/653

(52) U.S. Cl. CPC C08K 9/06; B01J 31/12; C08K 3/20; H01M 10/653; C08K 2003/2227; H01M 2220/20

(57) ABSTRACT

A gap filler composition according to an embodiments includes a siloxane-based resin, a filler, and a catalyst. After application under conditions of 23° C. and 50% relative humidity, the Shore 00 hardness measured after leaving for 60 minutes and the Shore 00 hardness measured after leaving for 120 minutes are in the range of 40 to 70. The gap filler composition can be used to manufacture a vehicle battery pack including a gap filler having improved thermal stability and process properties.

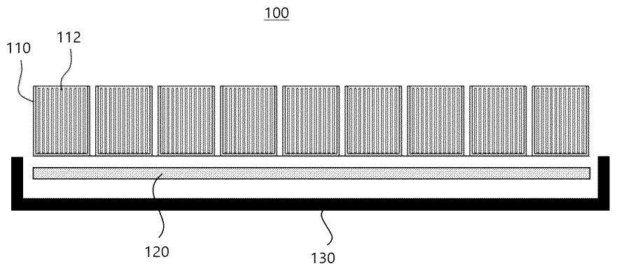

### CROSS-REFERENCE TO RELATED APPLICATION AND CLAIM OF PRIORITY

The present application is a continuation application to International Application No. PCT/KR2024/000577 with an International Filing Date of Jan. 12, 2024, which claims the benefit of Korean Patent Application No. 10-2023-0006628 filed on Jan. 17, 2023, at the Korean Intellectual Property Office, the disclosures of which are incorporated by reference herein in their entirety.

### BACKGROUND

### 1. Field

The present invention relates to a gap filler composition and a battery pack. More particularly, the present invention relates to a gap filler composition including a siloxane-based resin and a battery pack including a gap filler formed using the same.

### 2. Description of the Related Art

A secondary battery is a battery which may be repeatedly charged and discharged, and is widely applied as a power source for portable electronic devices such as a mobile phone, a laptop PC, or the like. For example, the lithium secondary battery has a high operating voltage, an energy density and rate properties, and has been used recently as a power source for electric vehicle.

For example, a battery cell is defined by a lithium secondary battery, and a plurality of the battery cells are assembled to form a battery module. The battery module may be assembled to form a high-capacity/high-power battery pack applicable to the electric vehicle.

To apply the battery pack to a vehicle such as the electric vehicle, the battery pack may be seated on a battery support plate, and the battery pack may be fixed using a gap filler composition.

The process of applying the gap filler composition may be included in an entire production platform of the electric vehicle. Thus, a gap filler composition that may be cured within a predetermined period to provide desired physical properties may be required to maintain efficiency/reliability of an automobile process.

Additionally, design of a composition capable of forming a gap filler having improved strength with respect to heat due to repeated charging/discharging of the battery pack and appropriate absorption/elasticity with respect to external impact is needed.

For example, Korean Registered Patent Registration No. 10-2402503 discloses a battery pack structure including a battery module and a gap filler. However, specific physical properties and a composition of the gap filler are not disclosed.

### SUMMARY

An object of the present invention is to provide a gap filler composition providing improved curing properties and mechanical stability.

An objective of the present invention is to provide a battery pack including a gap filler formed of the gap filler composition.
1. A gap filler composition including a siloxane-based resin, a filler and a catalyst, wherein a Shore 00 hardness measured after 60 minutes of being left and a Shore 00 hardness measured after 120 minutes of being left after application under conditions of 23° C. and 50% relative humidity are each in a range from 40 to 70.
2. The gap filler composition according to the above 1, wherein the siloxane-based resin includes a first siloxane-based resin having a vinyl terminal group, and a second siloxane-based resin having a hydrogen terminal group.
3. The gap filler composition according to the above 2, wherein the gap filler composition is prepared as a two-component composition separated into a main composition and a cross-linking composition, wherein the first siloxane-based resin is included in the main composition, and the second siloxane-based resin is included in the cross-linking composition.
4. The gap filler composition according to the above 3, wherein the catalyst is included in the main composition, and the filler is included by being divided in the main composition and the cross-linking composition.
5. The gap filler composition according to the above 1, wherein the catalyst includes an organic-inorganic hybrid compound including platinum (Pt) and a Si₂O group.
6. The gap filler composition according to the above 5, wherein a ratio of a weight of platinum relative to a weight of silicon and oxygen in the catalyst is in a range from 1.2 to 2.0.
7. The gap filler composition according to the above 5, wherein the ratio of the weight of platinum relative to the weight of silicon and oxygen in the catalyst is 1.2 to 1.5.
8. The gap filler composition according to the above 5, wherein a content of the catalyst based on a total weight of the composition is in a range from 0.02 wt % to 0.05 wt %.
9. The gap filler composition according to the above 1, wherein the filler includes alumina surface-treated with a silane agent,
10. The gap filler composition according to the above 9, wherein the silane agent includes three alkoxy groups and one alkyl group which are directly bonded to a silicon atom, and the number of carbon atoms of the alkyl group included in the silane agent is 8 or more.
11. The gap filler composition according to the above 10, wherein the number of carbon atoms of the alkyl group included in the silane agent is in a range from 8 to 16.
12. The gap filler composition according to the above 9, wherein a content of the filler based on a total weight of the composition is in a range from 70 wt % to 85 wt %.
13. The gap filler composition according to the above 1, wherein a hardness increase ratio represented by Equation 1 is 20% or less:

$$hardness increase ratio ( \% ) = \{ ( A - B ) / B \} * 100 \qquad [ Equation 1 ]$$

(In Equation 1, A is the Shore 00 hardness measured after being left for 120 minutes under conditions of 23° C. and 50% relative humidity after application of the gap filler composition, and B is the Shore 00 hardness measured after being left for 60 minutes under conditions of 23° C. and 50% relative humidity after application of the gap filler composition).
14. A battery pack, including a plurality of battery modules; a support plate; and a gap filler formed between the battery modules and the support plate using the gap filler composition according to the above-described embodiments.

A gap filler composition according to exemplary embodiments of the present invention may maintain a target hardness in a predetermined period range, and may provide quick and stable curing properties.

Accordingly, the gap filler composition may be applied to a vehicle battery pack to improve automobile process productivity and efficiency. Additionally, stable hardness/elastic properties may be provided even when a temperature increases due to repetition of charging/discharging of the battery pack.

In some embodiments, the gap filler composition may include a predetermined catalyst/filler combination to more effectively implement the above-described curing properties.

### BRIEF DESCRIPTION OF THE DRAWING

FIGURE is a schematic perspective view illustrating a battery pack in accordance with example embodiments.

### DETAILED DESCRIPTION OF THE EMBODIMENTS

According to embodiments of the present invention, a gap filler composition including a siloxane-based resin, a catalyst and a filler, and having improved curing properties is provided. Additionally, according to embodiments of the present invention, a battery pack using the gap filler composition is provided.

### <Gap Filler Composition>

A gap filler composition according to embodiments may include a siloxane-based resin, a catalyst and a filler.

The siloxane-based resin may be provided as a base component providing curability of the gap filler composition. According to embodiments, the siloxane-based resin may include a first siloxane-based resin and a second siloxane-based resin.

The first siloxane-based resin may be a siloxane-based resin containing a cross-linkable end group. According to embodiments, the first siloxane-based resin may be a siloxane-based resin containing a vinyl group at both ends of a molecule.

For example, the first siloxane-based resin may include a compound represented by Chemical Formula 1 below.

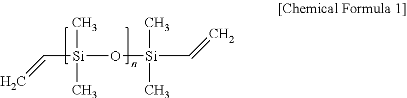

In some embodiments, the first siloxane-based resin may have a weight average molecular weight in a range from 10,000 to 50,000, preferably from 10,000 to 30,000, more preferably from 10,000 to 25,000.

In some embodiments, the first siloxane-based resin may have a viscosity in a range from 500 cps to 1,500 cps, preferably from 700 cps to 1,500 cps, more preferably from 800 cps to 1,200 cps at 25° C.

Within the molecular weight and viscosity range, curing properties and a curing rate may be more easily achieved as will be described later, and appropriate coating properties and flowability of the gap filler composition may be obtained.

In Chemical Formula 1, n may be adjusted in consideration of the molecular weight and viscosity range. For example, n may be a natural number in a range of 80 to 800, from 100 to 800, from 130 to 700, or from 150 to 700.

A content of the first siloxane resin based on a total weight (e.g., a solid content) of the gap filler composition may be in a range from 5 wt % to 20 wt %, preferably from 10 wt % to 20 wt %. Within the above content range, a gap filler having appropriate hardness and elasticity may be effectively formed.

The second siloxane-based resin may be a siloxane-based resin having a structure different from that of the first siloxane-based resin.

The second siloxane-based resin may be included as a chain extending agent or a chain adjusting agent of the gap filler composition, and thus overall viscosity, flowability, crosslinking property, etc., of the composition may be controlled.

According to embodiments, the second siloxane-based resin may be a siloxane-based resin which may not include a crosslinking group at an end thereof. For example, both ends of the second siloxane-based resin may be capped by hydrogen (H).

For example, the second siloxane-based resin may include a compound represented by Formula 2.

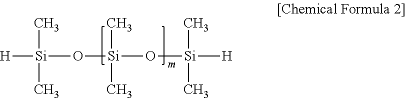

In some embodiments, the second siloxane-based resin may have a weight average molecular weight in a range from 10,000 to 50,000, preferably from 10,000 to 30,000, more preferably from 10,000 to 25,000.

In some embodiments, the second siloxane-based resin may have a viscosity in a range from 100 cps to 1,500 cps, preferably from 200 cps to 1,500 cps, more preferably from 300 cps to 1,200 cps at 25° C.

Within the molecular weight and viscosity range, curing properties and a curing rate described later may be more easily obtained, and appropriate coating properties and flowability of the gap filler composition may be achieved.

In Chemical Formula 2, m may be adjusted in consideration of the molecular weight and viscosity range. For example, m may be a natural number in a range from 20 to 700, from 30 to 700, from 50 to 700, from 100 to 700, or from 130 to 700.

A content of the second siloxane resin based on a total weight of the gap filler composition (e.g., a solid content) may be in a range from 5 wt % to 20 wt %, preferably from 10 wt % to 20 wt %. Within the above content range, a gap filler having appropriate hardness and elasticity may be effectively formed.

The catalyst may be used as a controller for promoting crosslinking and/or interaction of the first siloxane-based resin and/or the second siloxane-based resin of the gap filler composition to obtain the curing properties and curing rate as described below.

In example embodiments, the catalyst may include an organic-inorganic hybrid catalyst containing platinum and silicon.

The catalyst may contain a Pt atom and a Si₂O group (—Si—O—Si—) in a molecule. For example, silicon (Si) atoms of the Si₂O group may be bonded to a vinyl group, and the Pt atom may be coordinated or captured by the vinyl group.

According to embodiments, a weight ratio of platinum (Pt) relative to of the silicon (Si) atom and an oxygen atom (0) in the catalyst may be in a range from 1.2 to 2.0, preferably from 1.2 to 1.5, more preferably from 1.25 to 1.45.

Proper activity of the catalyst through the Pt atom may be maintained by using the catalyst in the weight ratio range. Therefore, the curing properties and curing rate of the gap filler composition as described below may be easily implemented using the catalyst.

For example, the catalyst may include a unit represented by Chemical Formula 3 below in the molecule.

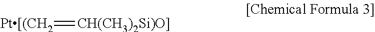

In some embodiments, a content of the catalyst based on the total weight of the composition may be in a range from 0.02 wt % to 0.05 wt %. Within the above range, an appropriate curing rate may be implemented while preventing an excessive increase in hardness/elasticity of the gap filler.

The filler may be included as a component that may increase a thermal conductivity of the gap filler to improve heat dissipation properties of a battery pack. According to embodiments, the filler may include ceramic particles such as alumina (Al₂O₃), aluminum nitride (AlN), boron nitride (BN), silicon nitride (silicon nitride), SiC, ZnO, aluminum hydroxide (Al(OH)₃), boehmite, BeO, or the like.

In a preferable embodiment, the filler may include alumina.

In example embodiments, the filler may include alumina surface-treated with a silane agent. The silane agent may be chemically bonded or buried on a surface of alumina particles to stabilize the filler through interaction with the siloxane-based resin.

Thus, the filler may be uniformly dispersed in the gap filler composition to implement uniform heat conduction properties in the battery pack.

The silane agent may include three alkoxy groups and one alkyl group directly bonded to a silicon atom. The alkoxy group may be a methoxy group.

According to embodiments, the number of carbon atoms of the alkyl group included in the silane agent may be 8 or more. In this case, interaction with the siloxane-based resin may be effectively promoted.

In some embodiments, the number of carbon atoms of the alkyl group included in the silane agent may be in a range from 8 to 16, preferably from 8 to 12. In this case, a decrease in dispersibility due to an excessive increase of the number of carbon atoms may be prevented.

In some embodiments, the filler may include a plurality of types of alumina particles having different average particle diameters. Accordingly, packing and distribution properties of the alumina particles in the composition may be improved, and heat conduction properties may be improved.

In an embodiment, the filler may include alumina particles having an average particle diameter (D50) of 50 μm or more and alumina particles having an average particle diameter (D50) of 30 μm or less. In an embodiment, the alumina particles having an average particle diameter (D50) of 30 μm or less may include alumina particles having an average particle diameter (D50) of 10 μm to 30 μm and alumina particles having an average particle diameter (D50) of less than 10 μm.

The term “average particle diameter (D50)” used in this application may refer to a medium particle diameter corresponding to 50% in a cumulative distribution (distribution based on the number of particles) in which the particles are arranged in an order of sizes.

The filler may be included in the largest amount of the gap filler composition. For example, the filler may be included in the gap filler composition in a residual amount excluding the siloxane-based resin and the catalyst.

The term “residual amount” used in the present application is used in a variable amount which varies depending on an amount of an additive when the gap filler composition includes another additive in addition to the siloxane-based resin, the catalyst, and the filler. For example, the residual amount may be an amount excluding the siloxane-based resin, the catalyst, and the additive based on a total weight of the composition.

For example, a content of the filler may be in a range from 70 wt % to 85 wt %, preferably from 75 wt % to 85 wt % based on the total weight of the composition. The amount of the filler may be calculated to include an amount of the surface-treated silane agent.

In some embodiments, the gap filler composition may further include the additive for enhancing the conductivity and curability of the composition within a range that does not inhibit the functions of the siloxane-based resin, the catalyst, and the filler. For example, the additive may include a flame retardant, a dispersant, a colorant, an antioxidant, a plasticizer, or the like.

For example, examples of the flame retardant may include an organic flame retardant such as melamine cyanurate, and an inorganic flame retardant such as magnesium hydroxide. In an embodiment, a liquid type flame retardant material (triethyl phosphate (TEP) or tris(1,3-chloro-2-propyl)phosphate (TCPP), etc.) may be used.

According to embodiments, the gap filler composition may be prepared as a two-component composition. For example, the gap filler composition may be prepared by separately preparing a main composition and a cross-linking composition, and then mixing the main composition and the cross-linking composition.

The main composition may include the first siloxane-based resin, the catalyst, and the filler. The cross-linking composition may include the second siloxane-based resin and the filler.

For example, the second siloxane-based resin may be mixed in a state in which the catalyst is distributed with the first siloxane-based resin in the main composition. Thus, the second siloxane-based resin may be introduced in a state in which cross-linking points are distributed in the main composition, so that curing efficiency may be improved.

The filler may be divided and included in the main composition and the cross-linking composition. In an embodiment, a ratio of an amount of the filler contained in the main composition to an amount of the filler contained in the cross-linking composition may be in a range from 0.4 to 0.6, preferably from 0.45 to 0.55. Within the ratio range, heat conduction efficiency may be improved by uniform distribution of the filler.

According to embodiments of the present invention, a Shore 00 hardness measured after being left for 60 minutes and a Shore 00 hardness measured after being left for 120 minutes under conditions of 23° C. and 50% relative humidity after an application of the gap filler composition may each be in a range from 40 to 70.

If the hardnesses after being left for 60 minutes and after being left for 120 minutes are less than 40, overall production efficiency may be degraded due to increase in a process time of applying a battery pack to an electric vehicle. Further, curability of the gap filler may become excessively low, and mechanical stability of the battery pack may be deteriorated.

If the hardnesses after being left for 60 minutes and after being left for 120 minutes exceed 120, sufficient shock absorption properties for the battery pack may not be implemented from the gap filler due to an excessive increase in a curing rate. Additionally, thermal conduction properties through the filler may be hindered by an excessive degree of cross-linking.

In a preferred embodiment, the hardnesses after being left for 60 minutes and after being left for 120 minutes may each be in a range from 50 to 70, more preferably from 50 to 65.

In some embodiments, a hardness increase ratio represented by Equation 1 below may be 20% or less, preferably in a range from 10% to 20%.

$$hardness increase ratio ( \% ) = \{ ( A - B ) / B \} * 100 \qquad [ Equation 1 ]$$

In Equation 1, A is the Shore 00 hardness measured after being left for 120 minutes under conditions of 23° C. and 50% relative humidity after application of the gap filler composition, and B is the Shore 00 hardness measured after being left for 60 minutes under conditions of 23° C. and 50% relative humidity after application of the gap filler composition.

Within the hardness increase ratio range, the gap filler composition may effectively provide high temperature stability of the gap filler while maintaining a stable curing rate.

The Shore 00 hardness may be measured according to ASTM D 2240 standard. For example, the Shore 00 hardness may be measured with respect to a cured film obtained by applying and curing the gap filler composition to a thickness of 6 mm.

### <Battery Pack>

FIGURE is a schematic perspective view illustrating a battery pack in accordance with example embodiments.

Referring to FIGURE, a battery pack 100 may include a battery module 110 and a support plate 130, and may include a gap filler 120 formed on the battery module 110 and the support plate 130.

The battery module 110 may include a plurality of battery cells 112. Each of the battery cells 112 may include an electrode assembly including a cathode and an anode alternately and repeatedly stacked. The cathode and the anode may be alternately and repeatedly stacked with a separator interposed therebetween. The cathode may include a lithium metal oxide as a cathode active material, and the battery cell 112 may be provided as a lithium secondary battery.

Each of the plurality of battery cells 112 may include a cathode lead and an anode lead, and the cathode leads and the anode leads may be merged with each other through a busbar to define the battery module 110.

The battery module 110 may be fixed on the support plate 130. The gap filler composition according to the above-described embodiments may be applied and cured between the battery module 110 and the support plate 130 to form the gap filler 120.

The battery module 110 may be stably fixed on the support plate 130 by the gap filler 120. As described above, the gap filler 120 may have stable curing properties and improved thermal conduction properties.

According to embodiments, the gap filler composition may maintain a target hardness range within a predetermined time range. Thus, stable hardness properties may be maintained without deteriorating overall efficiency of an electric vehicle process.

Thus, the battery module 110 may have impact resistance and heat resistance for protecting the battery module 110 even under high temperature conditions, and may provide sufficient heat dissipation properties.

The gap filler 120 may be provided as a thermal conductive layer. For example, a thermal conductivity of the gap filler 120 may be about 2 W/mK or more, 3 W/mK or more, 4 W/mK or more, or 5 W/mK or more. For example, the thermal conductivity of the gap filler 120 may be about 50 W/mK or less, 40 W/mK or less, 30 W/mK or less, 20 W/mK or less, or 10 W/mK or less. For example, the thermal conductivity may be measured according to ASTM D5470 standard.

According to embodiments, a height of the gap filler 120 on which the battery module 110 is seated may be from 5.4 mm to 5.8 mm, preferably from 5.4 mm to 5.7 mm. In the above range, sufficient support stability for the battery module 110 may be provided, and sufficient heat conduction properties may be implemented. Further, a gap generation between the battery module 110 and the gap filler 120 due to an excessive hardening may be prevented.

Hereinafter, experimental examples including specific examples and comparative examples are presented to enhance the understanding of the present invention, but this only exemplifies the present invention and does not limit the scope of the attached patent claims, and it is clear to those skilled in the art that various changes and modifications to embodiments can be made within the scope of the present invention and technical ideas, and it is obvious that these modifications and modifications are included in the range of to the attached patent claims.

### EXAMPLES AND COMPARATIVE EXAMPLES

A main composition and a cross-linking composition having components and contents (parts by weight) shown in Tables 1 and 2 below were each prepared. Alumina surface-treated with a silane agent was used as a filler, and 52.93 g of the filler was equally included in each of the main composition and the cross-linking composition.

In Comparative Example 4, a mixture of alumina surface-treated with a silane agent and aluminum hydroxide was used as a filler (a mixture of weight ratio 6:4).

Specifically, in each of the main composition and the cross-linking composition, the components of Table 1 were put into a paste mixer, mixed and stirred at 600 rpm of revolution/500 rpm of rotation for 3 minutes, and then degassed for 10 minutes at 1000 rpm of revolution/100 rpm of rotation in a vacuum state.

TABLE 1

| | | | Example | Example | Example | Example | Example | Example |
|---|---|---|---|---|---|---|---|---|
| category | | | 1 | 2 | 3 | 4 | 5 | 6 |
| main | first siloxane- | | 14.05 | 14.07 | 14.03 | 14.05 | 14.05 | 14.05 |
| composition | based resin (A) | | | | | | | |
| | catalyst | B-1 | 0.05 | 0.03 | 0.07 | 0.05 | 0.05 | 0.05 |
| cross- | second | C-1 | 13.93 | 13.93 | 13.93 | 13.93 | 13.93 | 13.93 |
| linking | siloxane- | C-2 | 0.1407 | 0.1407 | 0.1407 | 0.1407 | 0.1407 | 0.1407 |
| composition | based | | | | | | | |
| | resin | | | | | | | |

| | | | | | | | |
|---|---|---|---|---|---|---|---|
| filler | silane agent 1 | 52.93 | 52.93 | 52.93 | — | — | — |
| | silane agent 2 | — | — | — | 52.93 | — | — |
| | silane agent 3 | — | — | — | — | 52.93 | — |
| | silane agent 4 | — | — | — | — | — | 52.93 |

TABLE 2

| | | | Comparative | Comparative | Comparative | Comparative | Comparative |
|---|---|---|---|---|---|---|---|
| category | | | Example 1 | Example 2 | Example 3 | Example 4 | Example 5 |
| main | first siloxane- | | 14.09 | 14.01 | 14.05 | 14.05 | 14.08 |
| composition | based resin (A) | | | | | | |
| | catalyst | B-1 | 0.01 | 0.09 | 0.05 | 0.05 | — |
| | | B-2 | — | — | — | — | 0.02 |
| cross- | second | C-1 | 13.93 | 13.93 | 13.93 | 13.93 | 13.93 |
| linking | siloxane- | C-2 | 0.1407 | 0.1407 | 0.1407 | 0.1407 | 0.1407 |
| composition | based resin | | | | | | |

| | | | | | | |
|---|---|---|---|---|---|---|
| filler | silane agent 1 | 52.93 | 52.93 | — | — | 52.93 |
| | silane agent 2 | — | — | — | — | — |
| | silane agent 3 | — | — | — | — | — |
| | silane agent 4 | — | — | — | — | — |
| | silane agent 5 | | | 52.93 | 52.93 | -— |

Specific components shown in Tables 1 and 2 are as follows.
1) first siloxane-based resin (A): polydimethylsiloxane resin both ends of which are treated with vinyl groups (weight average molecular weight: 25,000; median viscosity: 1,000 cpm) (manufactured by Sigma-Aldrich)
2-1) Catalyst (B-1): compound of Chemical Formula 3-1 (Pt/(Si+O) weight ratio: 1.35)

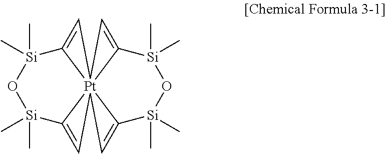

2-2) Catalyst (B-2): compound of Chemical Formula 3-2 below having Pt/(Si+O) weight ratio of about 1.1

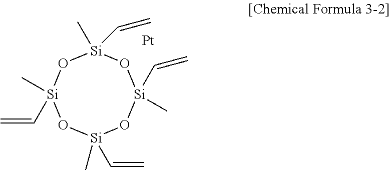

3-1) second siloxane-based resin (C-1): polydimethylsiloxane resin having both ends treated with hydrogen (product name: RF-HD0050, Biogen)
3-2) second siloxane-based resin (C-2): polydimethylsiloxane resin having both ends treated with hydrogen (product name: XL-02, Biogen)
4-1) silane agent 1: compound of Chemical Formula 4-1 below (8 carbon atoms of alkyl group bonded to silicon atom)

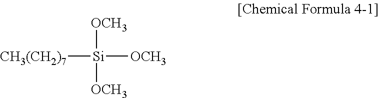

4-2) silane agent 2: compound of Chemical Formula 4-2 below (10 carbon atoms of alkyl group bonded to silicon atom)

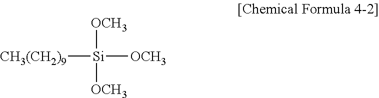

4-3) silane agent 3: compound of Chemical Formula 4-3 below (12 carbon atoms of alkyl group bonded to silicon atom)

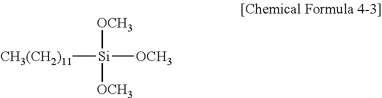

4-4) silane agent 4: compound of Chemical Formula 4-4 below (16 carbon atoms of alkyl group bonded to silicon atom)

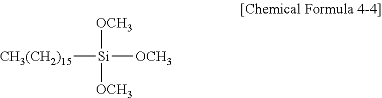

4-5) silane agent 5: compound of Chemical Formula 4-5 below (6 carbon atoms of alkyl group bonded to silicon atom)

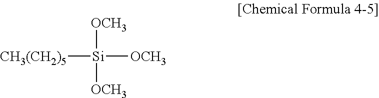

### Experimental Example

### (1) Hardness Measurement

The main composition and the cross-linking composition of Examples and Comparative Examples were mixed and charged at a mass ratio of 1:1 using a two-component cartridge and applied to a JIG having a thickness of 6 mm, and then a hardness of a cured product surface was measured according to ASTM D 2240 standard under conditions of 50% relative humidity and 23° C. In the hardness measurement, ASKER Durometer was used. The curing was performed in a state applying a load of about 0.5 kg, and Shore00/A hardness was evaluated by confirming a stabilized measurement value 15 seconds after removing the load every 10 minutes.

The hardness was measured 60 minutes after the initiation of curing and 120 minutes after the initiation of curing under the above conditions.

### (2) Battery Pack Seating Test

The gap filler composition prepared as shown in the above (1) was applied to a JIG of 90 mm*70 mm*6 mm (width×length×height), and the JIG was removed after 1 hour.

A battery pack manufactured at a weight of 0.22 g/mm² was mounted on the formed gap filler, and a height was measured 120 minutes after the initial application of the gap filler composition.

The evaluation results are shown in Table 3 below.

TABLE 3

| | Example | Example | Example | Example | Example | Example |
|---|---|---|---|---|---|---|
| | 1 | 2 | 3 | 4 | 5 | 6 |
| hardness | 54 | 58 | 57 | 52 | 50 | 57 |
| after 60 minutes | | | | | | |
| hardness | 63 | 60 | 66 | 60 | 57 | 52 |
| after 120 minutes | | | | | | |
| battery seating | 5.60 | 5.65 | 5.65 | 5.55 | 5.5 | 5.65 |
| test | | | | | | |

TABLE 4

| | Comparative | Comparative | Comparative | Comparative | Comparative |
|---|---|---|---|---|---|
| | Example 1 | Example 2 | Example 3 | Example 4 | Example 5 |
| hardness after | 31 | 74 | 68 | 68 | 38 |
| 60 minutes | | | | | |
| hardness after | 38 | 81 | 75 | 75 | 61 |
| 120 minutes | | | | | |
| battery | 5.30 | 5.85 | 5.75 | 5.75 | 5.35 |
| seating test | | | | | |

Referring to Table 3 and Table 4, a stable gap filler height was achieved after the battery module was seated in Examples where the hardness was in a range from 40 to 70 after 60 minutes and 120 minutes.

In Comparative Example 1, the content of the catalyst was excessively decreased, and the hardness properties were deteriorated, and a height of the gap filler was also decreased. In Comparative Example 2, a curing rate was excessively increased due to the excessive content of the catalyst.

In Comparative Example 5, the Pt/(Si+O) weight ratio of the catalyst was reduced, and curing properties were excessively degraded.

What is claimed is:

1. A gap filler composition comprising:
a siloxane-based resin;
a filler; and
a catalyst,
wherein, a Shore 00 hardness measured after 60 minutes of being left and a Shore 00 hardness measured after 120 minutes of being left after application under conditions of 23° C. and 50% relative humidity are each in a range from 40 to 70.

2. The gap filler composition according to claim 1, wherein the siloxane-based resin comprises a first siloxane-based resin having a vinyl terminal group, and a second siloxane-based resin having a hydrogen terminal group.

3. The gap filler composition according to claim 2, wherein the gap filler composition is prepared as a two-component composition separated into a main composition and a cross-linking composition,
wherein the first siloxane-based resin is included in the main composition, and the second siloxane-based resin is included in the cross-linking composition.

4. The gap filler composition according to claim 3, wherein the catalyst is included in the main composition, and the filler is included by being divided in the main composition and the cross-linking composition.

5. The gap filler composition according to claim 1, wherein the catalyst comprises an organic-inorganic hybrid compound including platinum (Pt) and a Si₂O group.

6. The gap filler composition according to claim 5, wherein a ratio of a weight of platinum relative to a weight of silicon and oxygen in the catalyst is in a range 5 from 1.2 to 2.0.

7. The gap filler composition according to claim 5, wherein the ratio of the weight of platinum relative to the weight of silicon and oxygen in the catalyst is 1.2 to 1.5.

8. The gap filler composition according to claim 5, wherein a content of the catalyst based on a total weight of the composition is in a range from 0.02 wt % to 0.05 wt %.

9. The gap filler composition according to claim 1, wherein the filler comprises alumina surface-treated with a silane agent.

10. The gap filler composition according to claim 9, wherein the silane agent comprises three alkoxy groups and one alkyl group which are directly bonded to a silicon atom, and
the number of carbon atoms of the alkyl group included in the silane agent is 8 or 20 more.

11. The gap filler composition according to claim 10, wherein the number of carbon atoms of the alkyl group included in the silane agent is in a range from 8 to 16.

12. The gap filler composition according to claim 9, wherein a content of the filler based on a total weight of the composition is in a range from 70 wt % to 85 wt %.

13. The gap filler composition according to claim 1, wherein a hardness increase ratio represented by Equation 1 is 20% or less:
$$hardness increase ratio ( \% ) = \{ ( A - B ) / B \} * 100 \qquad [ Equation 1 ]$$
wherein A is the Shore 00 hardness measured after being left for 120 minutes under conditions of 23° C. and 50% relative humidity after application of the gap filler composition; and
B is the Shore 00 hardness measured after being left for 60 minutes under conditions of 23° C. and 50% relative humidity after application of the gap filler composition.

14. A battery pack, comprising:
a plurality of battery modules; and
a support plate; and
a gap filler formed between the battery modules and the support plate using the gap filler composition of claim 1.
